(19) United States
(12) Patent Application Publication
(10) Pub. No.: US 2023/0216056 A1
(43) Pub. Date: Jul. 6, 2023

(54) AQUEOUS POLYURETHANE RESIN DISPERSION FOR BINDERS THAT ARE USED IN LITHIUM SECONDARY BATTERIES, BINDER FOR ELECTRODES, AND LITHIUM SECONDARY BATTERY

(71) Applicant: DKS CO. LTD., Kyoto-shi, Kyoto (JP)

(72) Inventors: Ayano SOFUE, Kyoto-shi (JP); Fumiya KANEKO, Kyoto-shi (JP); Toshiya WATANABE, Kyoto-shi (JP); Yasuteru SAITO, Kyoto-shi (JP); Soki KAJI, Kyoto-shi (JP)

(73) Assignee: DKS CO. LTD., Kyoto-shi, Kyoto (JP)

(21) Appl. No.: 18/014,538

(22) PCT Filed: Oct. 6, 2021
(86) PCT No.: PCT/JP2021/037059

§ 371 Date: Jan. 5, 2023

(30) Foreign Application Priority Data
Oct. 21, 2020 (JP) 2020-176839

(51) Int. Cl. H01M 4/62; H01M 10/052

(52) U.S. Cl. CPC H01M 4/622; H01M 10/052

(57) ABSTRACT

A technology related to a binder that exhibits good ionic conductivity, binding properties, and discharge retention rate is provided.

An aqueous polyurethane resin dispersion for binders that are used in lithium secondary batteries is an aqueous polyurethane resin dispersion including a polyurethane resin dispersed in water, the polyurethane resin being obtained by reacting a polyisocyanate compound (a), a compound (b) having two or more active hydrogen groups, a compound (c) having a hydrophilic group and one or more active hydrogen groups, and a chain extender (d) . The compound (b) contains a polyolefin (b1) having two or more active hydrogen groups and a polycarbonate (b2) having two or more active hydrogen groups and having 6 or less consecutive carbon atoms. A crosslink density per molecular weight of 1,000 of a resin solid component contained in the aqueous polyurethane resin dispersion is 0.02 mol/kg or more and 0.28 mol/kg or less.

### TECHNICAL FIELD

The present invention relates to an aqueous polyurethane resin dispersion for binders that are used in lithium secondary batteries, a binder for electrodes, and a lithium secondary battery.

### BACKGROUND ART

Heretofore, it has been known that secondary batteries are used as power sources for mobile terminals such as notebook personal computers, mobile phones, and personal digital assistants (PDA) (for example, PTL 1).

In PTL 1, PTL 2, and PTL 3, styrene butadiene rubber (SBR) is used as binders used for electrodes of secondary batteries.

### CITATION LIST

### Patent Literature

PTL 1: Japanese Unexamined Patent Application Publication No. 5-21068
PTL 2: Japanese Unexamined Patent Application Publication No. 11-7948
PTL 3: Japanese Unexamined Patent Application Publication No. 2001-210318

### SUMMARY OF INVENTION

### Technical Problem

However, the binders described in PTL 1, PTL 2, and PTL 3 are insulating materials, cannot maintain the structures of the electrodes and conduction paths as discharging and charging are repeated, and thus have room for improvement in the ionic conductivity and discharge retention rate. Accordingly, there has been a demand for the development of a technology related to a binder that exhibits good ionic conductivity, binding properties, and discharge retention rate.

### Solution to Problem

The present invention has been made in order to solve the problem described above, and can be realized as the following aspects.

(1) According to an aspect of the present invention, there is provided an aqueous polyurethane resin dispersion for binders that are used in lithium secondary batteries. The aqueous polyurethane resin dispersion for binders is an aqueous polyurethane resin dispersion including a polyurethane resin dispersed in water, the polyurethane resin being obtained by reacting a polyisocyanate compound (a), a compound (b) having two or more active hydrogen groups, a compound (c) having a hydrophilic group and one or more active hydrogen groups, and a chain extender (d), in which the compound (b) contains a polyolefin (b1) having two or more active hydrogen groups and a polycarbonate (b2) having two or more active hydrogen groups and having 6 or less consecutive carbon atoms, and a crosslink density per molecular weight of 1,000 of a resin solid component contained in the aqueous polyurethane resin dispersion is 0.02 mol/kg or more and 0.28 mol/kg or less.

According to this aspect, a binder for lithium secondary batteries, the binder exhibiting good ionic conductivity, binding properties, and discharge retention rate, can be provided.

(2) In the aqueous polyurethane resin dispersion for binders of the above aspect, an amount of the polycarbonate (b2) may be 5 parts by mass or more and 95 parts by mass or less relative to 100 parts by mass of a total blending amount of the polyolefin (b1) and the polycarbonate (b2).

According to this aspect, binding properties can be improved.

(3) In the aqueous polyurethane resin dispersion for binders of the above aspect, an amount of the polycarbonate (b2) may be 40 parts by mass or more and 80 parts by mass or less relative to 100 parts by mass of a total blending amount of the polyolefin (b1) and the polycarbonate (b2).

According to this aspect, binding properties can be improved.

(4) In the aqueous polyurethane resin dispersion for binders of the above aspect, the polyisocyanate compound (a) may include at least one of an aromatic polyisocyanate and an alicyclic polyisocyanate.

According to this aspect, a binder for lithium secondary batteries, the binder exhibiting better binding properties and discharge retention rate, can be provided.

(5) In the aqueous polyurethane resin dispersion for binders of the above aspect, the polyolefin (b1) may include a polyolefin containing two or more hydroxy groups.

According to this aspect, a binder for lithium secondary batteries, the binder exhibiting better binding properties and discharge retention rate, can be provided.

(6) In the aqueous polyurethane resin dispersion for binders of the above aspect, the polycarbonate (b2) may include a polycarbonate containing two or more hydroxy groups.

According to this aspect, a binder for lithium secondary batteries, the binder exhibiting better ionic conductivity and discharge retention rate, can be provided.

(7) In the aqueous polyurethane resin dispersion for binders of the above aspect, the compound (c) may include a compound having an active hydrogen group and a carboxy group.

According to this aspect, a binder for lithium secondary batteries, the binder exhibiting good ionic conductivity, binding properties, and discharge retention rate, can be provided.

(8) In the aqueous polyurethane resin dispersion for binders of the above aspect, the chain extender (d) may include a triamine.

According to this aspect, electrolyte solution resistance can be improved.

(9) In the aqueous polyurethane resin dispersion for binders of the above aspect, an amount of the chain extender (d) may be 0.2 parts by mass or more and 1 part by mass or less relative to 100 parts by mass of a total blending amount of the polyisocyanate compound (a), the compound (b), the compound (c), and the chain extender (d).

According to this aspect, a binder for lithium secondary batteries, the binder exhibiting good ionic conductivity, binding properties, and discharge retention rate, can be provided.

(10) According to another aspect of the present invention, there is provided a binder for electrodes, the binder containing the aqueous polyurethane resin dispersion for binders of the above aspect.

(11) According to another aspect of the present invention, there is provided a lithium secondary battery including an electrode using the binder for electrodes of the above aspect.

### DESCRIPTION OF EMBODIMENTS

Preferred embodiments of the present invention will be described below.

### Aqueous Polyurethane Resin Dispersion

An aqueous polyurethane resin dispersion for binders that are used in lithium secondary batteries (hereinafter, also simply referred to as an “aqueous polyurethane resin dispersion”) which is an embodiment of the present invention is an aqueous polyurethane resin dispersion including a polyurethane resin dispersed in water, the polyurethane resin being obtained by reacting a polyisocyanate compound (a), a compound (b) having two or more active hydrogen groups, a compound (c) having a hydrophilic group and one or more active hydrogen groups, and a chain extender (d). The compound (b) contains a polyolefin (b1) having two or more active hydrogen groups and a polycarbonate (b2) having two or more active hydrogen groups and having 6 or less consecutive carbon atoms. A crosslink density per molecular weight of 1,000 of a resin solid component contained in the aqueous polyurethane resin dispersion is 0.02 mol/kg or more and 0.28 mol/kg or less. In the present description, the “active hydrogen group” refers to a functional group that reacts with an isocyanate group, and examples thereof include a hydroxy group, a primary amino group, a secondary amino group, and a thiol group. The active hydrogen group is preferably a hydroxy group.

The use of the aqueous polyurethane resin dispersion of this embodiment as a binder used in lithium secondary batteries provides a binder that exhibits good ionic conductivity, binding properties, and discharge retention rate. Although the mechanism for this is not clear, the following mechanism is conceivable. That is, if the polyolefin is used alone as the compound having two or more active hydrogen groups, there is a problem in that the ionic conductivity is poor. However, by using, in combination, the polycarbonate having two or more active hydrogen groups and having 6 or less consecutive carbon atoms, good ionic conductivity, binding properties, and discharge retention rate are considered to be realized. In addition, since the crosslink density per molecular weight of 1,000 of the resin solid component contained in the aqueous polyurethane resin dispersion is within the range described above, probably, a certain strength can be maintained even in the state where the polycarbonate component is swollen in an electrolyte solution, and thus a good discharge retention rate is realized.

The crosslink density per molecular weight of 1.000 of the resin solid component contained in the aqueous polyurethane resin dispersion is more preferably 0.03 mol/kg or more, still more preferably 0.04 mol/kg or more, and particularly preferably 0.05 mol/kg or more. The crosslink density is preferably 0.25 mol/kg or less, more preferably 0.20 mol/kg or less, and particularly preferably 0.10 mol/kg or less.

The crosslink density in the present description can be calculated by the following method. That is, it is possible to determine, by calculation using an expression below, the crosslink density per molecular weight of 1,000 of a resin solid component contained in an aqueous polyurethane resin dispersion obtained by reacting a mass W_{A1} g of a polyisocyanate compound (a) having a molecular weight MW_{A1} and a number F_{A1} of functional groups, a mass W_{A2} g of a polyisocyanate compound (a) having a molecular weight MW_{A2} and a number F_{A2} of functional groups, and a mass W_{Aj} g of a polyisocyanate compound (a) having a molecular weight MW_{Aj} and a number F_{Aj} of functional groups (where j is an integer of 1 or more) ; a mass W_{B1} g of a compound (b) having two or more active hydrogen groups and having a molecular weight MW_{B1} and a number F_{B1} of functional groups, a mass W_{B2} g of a compound (b) having two or more active hydrogen groups and having a molecular weight MW_{B2} and a number F_{B2} of functional groups, and a mass W_{Bk} g of a compound (b) having two or more active hydrogen groups and having a molecular weight MW_{Bk} and a number F_{Bk} of functional groups (where k is an integer of 1 or more) ; a mass W_{C1} g of a compound (c) having a hydrophilic group and one or more active hydrogen groups and having a molecular weight MW_{C1} and a number F_{C1} of functional groups, and a mass W_{Cm} g of a compound (c) having a hydrophilic group and one or more active hydrogen groups and having a molecular weight MW_{Cm} and a number F_{Cm} of functional groups (where m is an integer of 1 or more); and a mass W_{D1} g of a chain extender (d) having a molecular weight MW_{D1} and a number F_{D1} of functional groups, and a mass W_{Dn} g of a chain extender (d) having a molecular weight MW_{Dn} and a number F_{Dn} of functional groups (where n is an integer of 1 or more).

$$\begin{matrix}\text{Crosslink density =} \left(\frac{{\text{(W}}_{\text{A1}} ( {\text{F}}_{\text{A1}} - 2 ) / {\text{MW}}_{\text{A1}} ) {\text{+(W}}_{\text{A2}} ( {\text{F}}_{\text{A2}} - 2 ) / {\text{MW}}_{\text{A2}} ) + + ( {\text{W}}_{\text{A1}} ( {\text{F}}_{\text{A1}} - 2 ) / {\text{MW}}_{\text{A1}} )}{{\text{(W}}_{\text{A1}} + {\text{W}}_{\text{A2}} + + {\text{W}}_{\text{A1}} ) + ( {\text{W}}_{\text{B1}} + {\text{W}}_{\text{B2}} + {\text{+W}}_{\text{Rk}} ) + ( {\text{W}}_{\text{C1}} + + {\text{W}}_{\text{Cm}} ) + ( {\text{W}}_{\text{D1}} + {\text{+W}}_{\text{D2)}}}\right) + \\ \frac{( {\text{W}}_{\text{B1}} ( {\text{F}}_{\text{B1}} - 2 ) / {\text{MW}}_{\text{B1}} ) + ( {\text{W}}_{\text{B2}} ( {\text{F}}_{\text{B2}} - 2 ) / {\text{MW}}_{\text{B2}} ) + + ( {\text{W}}_{\text{Bk}} - 2 ) / {\text{MW}}_{\text{Bk}} )}{( {\text{W}}_{\text{A1}} + {\text{W}}_{\text{A2}} + + {\text{W}}_{\text{A1}} ) + ( {\text{W}}_{\text{B1}} + {\text{W}}_{\text{B2}} + + {\text{W}}_{\text{Bk}} ) = ( {\text{W}}_{\text{C1}} + + {\text{W}}_{\text{Cm}} ) + ( {\text{W}}_{\text{D1}} + + {\text{W}}_{\text{Dn}} )} + \\ \frac{( {\text{W}}_{\text{O1}} ( {\text{F}}_{\text{C1}} - 2 ) / {\text{MW}}_{\text{C1}} ) + - + ( {\text{W}}_{\text{Cm}} ( {\text{F}}_{\text{Cm}} - 2 ) / {\text{MW}}_{\text{Cm}} )}{( {\text{W}}_{\text{A1}} + {\text{W}}_{\text{A2}} + + {\text{W}}_{\text{A1}} ) + ( {\text{W}}_{\text{B1}} + {\text{W}}_{\text{B2}} + - + {\text{W}}_{\text{Bk}} ) + ( {\text{W}}_{\text{C1}} + - + {\text{W}}_{\text{Cm}} ) + ( {\text{W}}_{\text{D1}} + - + {\text{W}}_{\text{D1}} )} + \\ \left(\frac{( {\text{W}}_{\text{D1}} ( {\text{F}}_{\text{D1}} - 2 ) / {\text{MW}}_{\text{D1}} ) + - + ( {\text{W}}_{\text{Dn}} ( {\text{F}}_{\text{D0}} - 2 ) / {\text{MW}}_{\text{D0}} )}{( {\text{W}}_{\text{A1}} + {\text{W}}_{\text{A2}} + - + {\text{W}}_{\text{A1}} ) + ( {\text{W}}_{\text{B1+}} {\text{W}}_{\text{B2}} + - + {\text{W}}_{\text{Bk}} ) + ( {\text{W}}_{\text{C1}} + - + {\text{W}}_{\text{Cm}} ) + ( \text{W} {}_{\text{Dr}} + - + {\text{W}}_{\text{Dn}} )}\right) \times 1000\end{matrix}$$

### Polyisocyanate Compound (a)

Examples of polyisocyanate compounds include, but are not particularly limited to, organic polyisocyanates. Examples of organic polyisocyanates include, but are not particularly limited to, aliphatic polyisocyanates, alicyclic polyisocyanates, aromatic polyisocyanates, and araliphatic polyisocyanates. Examples of aliphatic polyisocyanates include tetramethylene diisocyanate, dodecamethylene diisocyanate, hexamethylene diisocyanate, 2,2,4-trimethylhexamethylene diisocyanate, 2,4,4-trimethylhexamethylene diisocyanate, lysine diisocyanate, 2-methylpentane-1,5-diisocyanate, and 3-methylpentane-1,5-diisocyanate. Examples of alicyclic polyisocyanates include isophorone diisocyanate, hydrogenated xylylene diisocyanate, 4,4′-dicyclohexylmethane diisocyanate, 1,4-cyclohexane diisocyanate, methylcyclohexylene diisocyanate, and 1,3-bis(isocyanatomethyl)cyclohexane. Examples of aromatic polyisocyanates include tolylene diisocyanate, 2,2′-diphenylmethane diisocyanate, 2,4′-diphenylmethane diisocyanate, 4,4′-diphenylmethane diisocyanate (MDI), 4,4′-dibenzyl diisocyanate, 1,5-naphthylene diisocyanate, xylylene diisocyanate, 1,3-phenylene diisocyanate, 1,4-phenylene diisocyanate, and hydrogenated diphenylmethane diisocyanate. Examples of araliphatic polyisocyanates include dialkyldiphenylmethane diisocyanates, tetraalkyldiphenylmethane diisocyanates, and α,α,α,α-tetramethylxylylene diisocyanate. Examples of polyisocyanate compounds further include dimers and trimers of these organic polyisocyanates and modified products such as biuret isocyanates. These polyisocyanate compounds may be used alone or in combination of two or more thereof.

From the viewpoint of good electrolyte solution resistance and binding properties, the polyisocyanate compound is preferably an aromatic polyisocyanate or an alicyclic polyisocyanate, and more preferably an alicyclic polyisocyanate. Specifically, the polyisocyanate compound is preferably 4,4′-dicyclohexylmethane diisocyanate, isophorone diisocyanate, or hydrogenated diphenylmethane diisocyanate, and more preferably hydrogenated diphenylmethane diisocyanate.

### Compound (b) Having Two or More Active Hydrogen Groups

The compound (b) having two or more active hydrogen group contains a polyolefin (b1) having two or more active hydrogen groups and a polycarbonate (b2) having two or more active hydrogen groups and having 6 or less consecutive carbon atoms.

### Polyolefin (b1) Having Two or More Active Hydrogen Groups

The polyolefin (b1) having two or more active hydrogen groups is a polyolefin containing two or more active hydrogen groups selected from the group consisting of a hydroxy group, a primary amino group, a secondary amino group, and a thiol group. The two or more active hydrogen groups contained in the polyolefin (b1) may be the same functional group or different functional groups. In the present description, the “polyolefin” refers to a polymer of an aliphatic hydrocarbon compound having a double bond, such as ethylene, propylene, butene, butadiene, or isoprene. From the viewpoint of good electrolyte solution resistance and binding properties, the polyolefin (b1) having two or more active hydrogen groups is preferably a polyolefin containing one or more hydroxy groups, and more preferably a polyolefin containing two or more hydroxy groups.

Examples of the polyolefin (b1) containing two or more hydroxy groups include, but are not particularly limited to, polybutadiene polyol, polyisoprene polyol, and polychloroprene polyol. Examples of the polyolefin (b1) containing two or more hydroxy groups further include polyolefins obtained by hydrogenating any of the above polyolefins and polyolefins obtained by copolymerizing another olefin compound with any of the above polyolefins.

The polyolefin (b1) having two or more active hydrogen groups is preferably polybutadiene polyol or polyisoprene polyol, and more preferably polybutadiene polyol.

### Polycarbonate (b2) Having Two or More Active Hydrogen Groups and Having 6 or Less Consecutive Carbon Atoms

In this embodiment, the polycarbonate (b2) having two or more active hydrogen groups and having 6 or less consecutive carbon atoms is used. The use of the polycarbonate having 6 or less consecutive carbon atoms achieves good affinity with an electrolyte solution when the aqueous polyurethane resin dispersion of this embodiment is used for a binder, and thus good ionic conductivity is achieved.

The polycarbonate (b2) has two or more active hydrogen groups selected from the group consisting of a hydroxy group, a primary amino group, a secondary amino group, and a thiol group and has 6 or less consecutive carbon atoms. The two or more active hydrogen groups contained in the polycarbonate (b2) may be the same functional group or different functional groups. From the viewpoint of good electrolyte solution resistance, ionic conductivity, binding properties, and discharge retention rate, the polycarbonate (b2) is preferably a polycarbonate containing one or more hydroxy groups, and more preferably a polycarbonate containing two or more hydroxy groups.

The polycarbonate (b2) is not particularly limited, and, for example, polycarbonate polyols that are commonly used in this technical field can be used. Examples of polycarbonate polyols include carbonate polyol of 1,6-hexanediol, carbonate polyol of 1,4-butanediol and 1,6-hexanediol, carbonate polyol of 1,5-pentanediol and 1,6-hexanediol, and carbonate polyol of 3-methyl-1,5-pentanediol and 1,6-hexanediol. More specifically, examples thereof include PCDL T-6001, T-6002, T-5651, T-5652, T-5650J, T-4671, and T-4672 manufactured by Asahi Kasei Corporation; Kuraray Polyols C-590, C-1050, C-1050R, C-1090, C-2050, C-2050R, C-2070, C-2070R, C-2090, C-2090R, C-3090, C-3090R, C-4090, C-4090R, C-5090, C-5090R, C-1065N, C-2065N, C-1015N, and C-2015N manufactured by Kuraray Co., Ltd.; and ETERNACOLL (registered trademark) UH-50, UH-100, UH-200, UH-300, UM-90 (3/1), UM-90 (1/1), UM-90 (⅓), and UC-100 manufactured by UBE Corporation.

The amount of polycarbonate relative to the total blending amount of the polyolefin (b1) and the polycarbonate (b2) is not particularly limited but is preferably 5 parts by mass or more, more preferably 30 parts by mass or more, and still more preferably 40 parts by mass or more from the viewpoint of ionic conductivity. The amount of polycarbonate relative to the total blending amount of the polyolefin (b1) and the polycarbonate (b2) is not particularly limited but is preferably 95 parts by mass or less, more preferably 80 parts by mass or less, and still more preferably 60 parts by mass or less from the viewpoint of electrolyte solution resistance.

### Compound (c) Having Hydrophilic Group and One or More Active Hydrogen Groups

In the present description, the “hydrophilic group” includes anionic hydrophilic groups, cationic hydrophilic groups, and nonionic hydrophilic groups. Examples of anionic hydrophilic groups include a carboxy group and salts thereof, and a sulfonic group and salts thereof. Examples of cationic hydrophilic groups include tertiary ammonium salts and quaternary ammonium salts. Examples of nonionic hydrophilic groups include groups composed of a repeating unit of ethylene oxide and groups composed of a repeating unit of ethylene oxide and a repeating unit of another alkylene oxide.

Examples of compounds containing one or more active hydrogen groups and one or more carboxy groups or salts thereof include carboxylic acid-containing compounds such as 2,2-dimethylolpropionic acid, 2,2-dimethylolbutyric acid, 2,2-dimethylolvaleric acid, dioxymaleic acid, 2,6-dioxybenzoic acid, and 3,4-diaminobenzoic acid, derivatives thereof, salts thereof, and, in addition, polyester polyols obtained using any of these. Examples thereof further include amino acids such as alanine, aminobutyric acid, aminocaproic acid, glycine, glutamic acid, aspartic acid, and histidine; and carboxylic acids such as succinic acid, adipic acid, maleic anhydride, phthalic acid, and trimellitic anhydride.

Examples of compounds having one or more active hydrogen groups and one or more sulfonic groups (or salts thereof) include sulfonic acid-containing compounds such as 2-oxyethanesulfonic acid, phenolsulfonic acid, sulfobenzoic acid, sulfosuccinic acid, 5-sulfoisophthalic acid, sulfanilic acid, 1,3-phenylenediamine-4,6-disulfonic acid, and 2,4-diaminotoluene-5-sulfonic acid; derivatives thereof; and polyester polyols, polyamide polyols, and polyamide polyester polyols obtained by copolymerizing these compounds.

By neutralizing the carboxy group or the sulfonic group to form a salt, the polyurethane that is finally obtained can be made water-dispersible. Examples of neutralizing agents in this case include nonvolatile bases such as sodium hydroxide and potassium hydroxide; tertiary amines such as trimethylamine, triethylamine, dimethylethanolamine, methyldiethanolamine, and triethanolamine; and volatile bases such as ammonia. The neutralization may be performed before urethane-forming reaction, during the reaction, or after the reaction.

Examples of compounds containing one or more active hydrogen groups and a tertiary ammonium salt include alkanolamines such as methylaminoethanol and methyldiethanolamine. By neutralizing such a compound with an organic carboxylic acid such as formic acid or acetic acid or an inorganic acid such as hydrochloric acid or sulfuric acid to form a salt, the polyurethane can be made water-dispersible. The neutralization may be performed before urethane-forming reaction, during the reaction, or after the reaction. Of these, a compound obtained by neutralizing methyldiethanolamine with an organic carboxylic acid is preferred from the viewpoint of the ease of emulsification.

Compounds having one or more active hydrogen groups and a quaternary ammonium salt are compounds obtained by quaternizing the above alkanolamine such as methylaminoethanol or methyldiethanolamine with an alkyl halide such as methyl chloride or methyl bromide or a dialkyl sulfate such as dimethyl sulfate. Of these, a compound obtained by quaternizing methyldiethanolamine with, for example, dimethyl sulfate is preferred from the viewpoint of the ease of emulsification.

Compounds having one or more active hydrogen groups and one or more nonionic hydrophilic groups are not particularly limited but are preferably compounds containing at least 30% by mass or more of repeating units of ethylene oxide and having a number-average molecular weight of 300 to 20,000. Examples thereof include nonionic group-containing compounds such as polyoxyethylene glycol, polyoxyethylene-polyoxypropylene copolymer glycol, polyoxyethylene-polyoxybutylene copolymer glycol, polyoxyethylene-polyoxyalkylene copolymer glycol, and monoalkyl ethers thereof; and polyester polyether polyols obtained by copolymerizing these compounds.

### Chain Extender (d)

Examples of the chain extender (d) include, but are not particularly limited to, diamines, triamines, and tetramines. Examples of diamines include ethylenediamine, trimethylenediamine, piperazine, and isophoronediamine. Examples of triamines include diethylenetriamine and dipropylenetriamine. Examples of tetramines include triethylenetetramine. In order to improve electrolyte solution resistance, the chain extender (d) is preferably a triamine, and more preferably diethylenetriamine.

The amount of chain extender (d) blended is not particularly limited but is preferably 0.1 parts by mass or more and 3 parts by mass or less, and more preferably 0.2 parts by mass or more and 1 part by mass or less relative to 100 parts by mass of the polyurethane resin from the viewpoint of achieving both electrolyte solution resistance and binding properties.

The solid content of the polyurethane resin in the aqueous polyurethane resin dispersion is not particularly limited but is preferably 1 part by mass or more and 60 parts by mass or less, more preferably 3 parts by mass or more and 55 parts by mass or less, and still more preferably 4 parts by mass or more and 50 parts by mass or less relative to 100 parts by mass of the aqueous polyurethane resin dispersion from the viewpoint of workability.

Furthermore, various additives that are commonly used can be used as necessary in the aqueous polyurethane resin dispersion. Examples of such additives include, but are not particularly limited to, weather-resistant agents, antibacterial agents, fungicides, pigments, rust inhibitors, dyes, film formation assistants, inorganic crosslinking agents, organic crosslinking agents, silane coupling agents, antiblocking agents, viscosity modifiers, leveling agents, antifoaming agents, dispersion stabilizers, light stabilizers, antioxidants, ultraviolet absorbents, inorganic fillers, organic fillers, plasticizers, lubricants, and antistatic agents. Examples of organic crosslinking agents include, but are not particularly limited to, blocked isocyanate crosslinking agents, epoxy crosslinking agents, carbodiimide crosslinking agents, oxazoline crosslinking agents, and melamine crosslinking agents.

### Method for Producing Aqueous Polyurethane Resin Dispersion

The method for producing an aqueous polyurethane resin dispersion is not particularly limited, and a publicly known method can be employed. The method for producing an aqueous polyurethane resin dispersion may be, for example, the following method. First, the polyisocyanate compound (a), the compound (b), and the compound (c) are reacted under reaction conditions of 30° C. to 130° C. for about 0.5 hours to 10 hours, and the resulting reaction mixture is then cooled to 5° C. to 45° C. as required. Thus, hydrophilic groups are neutralized or quaternization is performed by adding a quaternizing agent in advance to obtain a urethane prepolymer. Any organic solvent such as acetone, methyl ethyl ketone, tetrahydrofuran, dioxane, ethyl acetate, or butyl acetate can be used as a solvent. The urethane prepolymer is further emulsified and subjected to chain extension. Thus, an aqueous polyurethane resin dispersion can be produced. As for water used for emulsification, 100 to 900 parts by mass of water is preferably added relative to 100 parts by mass of the urethane prepolymer.

Next, a lithium secondary battery of this embodiment will be described. A positive electrode and a negative electrode used in the lithium secondary battery of this embodiment include, for example, an electrode active material, a conductive agent, a current collector for the electrode active material, and a binder that binds the electrode active material and the conductive agent to the current collector.

The lithium secondary battery of this embodiment includes an electrode produced by using a binder that includes the aqueous polyurethane resin dispersion of the above embodiment. The binder can be used in each of the positive electrode and the negative electrode and is used in either the positive electrode or the negative electrode.

In the lithium secondary battery of this embodiment, examples of binders that can be used for the electrode for which the aqueous polyurethane resin dispersion is not used include, but are not limited to, polyvinylidene fluoride, polyvinylidene fluoride copolymer resins such as copolymers of polyvinylidene fluoride and hexafluoropropylene, perfluoromethyl vinyl ether, and tetrafluoroethylene, fluororesins such as polytetrafluoroethylene and fluororubber, and polymers such as styrene-butadiene rubber, ethylene-propylene rubber, and styrene-acrylonitrile copolymers.

The positive electrode active material used for the positive electrode of the lithium secondary battery of this embodiment is not particularly limited as long as lithium ions can be intercalated and deintercalated. Examples thereof include metal oxides such as CuO, Cu₂O, MnO₂, MoO₃, V₂O₅, CrO₃, MoO₃, Fe₂O₃, Ni₂O₃, and CoO₃; composite oxides of lithium and transition metals, such as LiₓCoO₂, LiₓNiO₂, LiₓMn₂O₄, and LiFePO₄; metal chalcogenides such as TiS₂, MoS₂, and NbSe₃; and conductive polymer compounds such as polyacene, poly-p-phenylene, polypyrrole, and polyaniline. Among the above, composite oxides of lithium and one or more selected from transition metals such as cobalt, nickel, and manganese, which are generally called high-voltage materials, are preferred from the viewpoints of properties of releasing lithium ions and the ease of generation of a high voltage. Specific examples of composite oxides of lithium and cobalt, nickel, and manganese include LiCoO₂, LiMnO₂, LiMn₂O₄, LiNiO₂, LiNiₓCo₍₁₋ₓ₎O₂, and LiMnₐNi_{b}Co_{c} (a + b + c = 1). Furthermore, positive electrode active materials prepared by doping any of these lithium composite oxides with a small amount of element such as fluorine, boron, aluminum, chromium, zirconium, molybdenum, or iron and positive electrode active materials prepared by surface-treating the particle surface of any of the lithium composite oxides with, for example, carbon, MgO, Al₂O₃, or SiO₂ may also be used. These positive electrode active materials may be used in combination of two or more thereof.

As the negative electrode active material used for the negative electrode of this embodiment, any publicly known active material capable of intercalation and deintercalation of metallic lithium or lithium ions can be used without particular limitation. For example, carbon materials such as natural graphite, artificial graphite, non-graphitizable carbon, and graphitizable carbon may be used. Furthermore, for example, metal materials such as metallic lithium, alloys, and tin compounds, lithium transition metal nitrides, crystalline metal oxides, amorphous metal oxides, silicon compounds, and conductive polymers may also be used. Specific examples thereof include Li₄Ti₅O₁₂ and NiSi₅C₆.

A conductive agent is used in the positive electrode and the negative electrode of the lithium secondary battery of this embodiment. As the conductive agent, any electron-conductive material that does not adversely affect the battery performance can be used without particular limitation. Typically, carbon blacks such as acetylene black and ketjen black are used, and conductive materials such as natural graphite (e.g., scale graphite, flake graphite, and earthy graphite), artificial graphite, carbon whiskers, carbon fibers, metal (e.g., copper, nickel, aluminum, silver, and gold) powders, metal fibers, and conductive ceramic materials may also be used. These may be used as a mixture of two or more thereof. The addition amount thereof is preferably 0.1% to 30% by mass, and particularly preferably 0.2% to 20% by mass based on the amount of active material.

As current collectors for the electrode active materials of the lithium secondary battery of this embodiment, any electron conductor that causes no adverse effects in an assembled battery may be used. For example, as a positive electrode current collector, in addition to aluminum, titanium, stainless steel, nickel, baked carbon, conductive polymers, conductive glass, and the like, aluminum, copper, or the like whose surface is treatment with, for example, carbon, nickel, titanium, or silver for the purpose of improving adhesiveness, conductivity, and oxidation resistance may also be used. As a negative electrode current collector, in addition to copper, stainless steel, nickel, aluminum, titanium, baked carbon, conductive polymers, conductive glass, Al—Cd alloys, and the like, copper or the like whose surface is treatment with, for example, carbon, nickel, titanium, or silver for the purpose of improving adhesiveness, conductivity, and oxidation resistance may also be used. The surfaces of these current collector materials may be subjected to oxidation treatment. With regard to the shape thereof, not only a foil-like material but also film-like, sheet-like, and net-like materials, punched or expanded materials, and formed bodies such as a lath body, a porous body, and a foamed body are used. The thickness thereof is not particularly limited, but a current collector having a thickness of 1 to 100 µm is usually used.

The electrodes of the lithium secondary battery of this embodiment can be produced by mixing together, for example, an electrode active material, a conductive agent, and a binder that binds the electrode active material and the conductive agent to the current collector to prepare a slurry electrode material, applying the electrode material to aluminum foil, copper foil, or the like serving as a current collector, and volatilizing a dispersion medium.

In the electrode materials of this embodiment, a viscosity improver such as a water-soluble polymer may be used as a viscosity modifier to form a slurry. Specifically, one or two or more selected from, for example, celluloses such as carboxymethylcellulose salts, methylcellulose, ethylcellulose, hydroxymethylcellulose, hydroxypropylmethylcellulose, and hydroxyethylmethylcellulose; polycarboxylic acid compounds such as polyacrylic acid and sodium polyacrylate; compounds having a vinylpyrrolidone structure, such as polyvinylpyrrolidone; and polyacrylamide, polyethylene oxide, polyvinyl alcohol, sodium alginate, xanthan gum, carrageenan, guar gum, agar, and starch can be used. Of these, a carboxymethylcellulose salt is preferred.

The method, order, etc. of mixing of the electrode materials are not particularly limited. For example, the active material and the conductive agent may be mixed in advance and used, and for the mixing in such a case, a mortar, a mill mixer, a ball mill such as a planetary ball mill or a shaker ball mill, a mechanofusion, or the like may be used.

As a separator used for the lithium secondary battery of this embodiment, any separator used for typical lithium secondary batteries can be used without particular limitation. Examples thereof include porous resins made of polyethylene, polypropylene, polyolefin, polytetrafluoroethylene, or the like, ceramics, and nonwoven fabrics.

An electrolyte solution used for the lithium secondary battery of this embodiment may be any electrolyte solution used for typical lithium secondary batteries, and commonly used electrolyte solutions such as organic electrolyte solutions and ionic liquids may be used.

Examples of electrolyte salts used for the lithium secondary battery of this embodiment include LiPF₆, LiBF₄, LiClO₄, LiAsF₆, LiCl, LiBr, LiCF₃SO₃, LiN(CF₃SO₂)₂, LiC(CF₃SO₂)₃, LiI, LiAlCl₄, NaClO₄, NaBF₄, and NaI. In particular, inorganic lithium salts such as LiPF₆, LiBF₄, LiClO₄, and LiAsF₆ and organic lithium salts represented by LiN(SO₂CₓF₂ₓ₊₁) (SO₂C_{y}F_{2y+1}) are preferred. Here, x and y each represent 0 or an integer of 1 to 4, and x + y is 2 to 8. Examples of organic lithium salts include LiN(SO₂F)₂, LiN(SO₂CF₃) (SO₂C₂F₅), LiN(SO₂CF₃) (SO₂C₃F₇), LiN(SO₂CF₃) (SO₂C₄F₉), LiN (SO₂C₂F₅)₂, LiN (SO₂C₂F₅) (SO₂C₃F₇), and LiN (SO₂C₂F₅) (SO₂C₄F₉) . In particular, the use of, for example, LiPF₆, LiBF₄, LiN (CF₃SO₂)₂, LiN(SO₂F)₂, or LiN (SO₂C₂F₅)₂ as the electrolyte is preferred because good electrical properties are provided. The above electrolyte salts may be used alone or in combination of two or more thereof. It is desirable that these lithium salts be contained in the electrolyte solution at a concentration of typically 0.1 to 2.0 mol/L, preferably 0.3 to 1.5 mol/L.

An organic solvent for dissolving the electrolyte salt used for the lithium secondary battery of this embodiment may be any organic solvent used for non-aqueous electrolyte solutions for typical lithium secondary batteries, and examples thereof include carbonate compounds, lactone compounds, ether compounds, sulfolane compounds, dioxolane compounds, ketone compounds, nitrile compounds, and halogenated hydrocarbon compounds. Specific examples thereof include carbonates such as dimethyl carbonate, methyl ethyl carbonate, diethyl carbonate, ethylene carbonate, propylene carbonate, ethylene glycol dimethyl carbonate, propylene glycol dimethyl carbonate, ethylene glycol diethyl carbonate, and vinylene carbonate; lactones such as γ-butyl lactone; ethers such as dimethoxyethane, tetrahydrofuran, 2-methyltetrahydrofuran, tetrahydropyran, and 1,4-dioxane; sulfolanes such as sulfolane and 3-methylsulfolane; dioxolanes such as 1,3-dioxolane; ketones such as 4-methyl-2-pentanone; nitriles such as acetonitrile, propionitrile, valeronitrile, and benzonitrile; halogenated hydrocarbons such as 1,2-dichloroethane; and other solvents such as methyl formate, dimethylformamide, diethylformamide, dimethyl sulfoxide, and ionic liquids, e.g., imidazolium salts and quaternary ammonium salts. Furthermore, mixtures thereof may be used.

Of these organic solvents, in particular, one or more non-aqueous solvents selected from the group consisting of carbonates are preferably contained because good solubility of an electrolyte, good permittivity, and good viscosity are provided.

When a polymer electrolyte or a polymer gel electrolyte is used in the lithium secondary battery of this embodiment, examples thereof that can be used include polymers and crosslinked products thereof having a structure of a polymer or copolymer, which is a polymer compound, of ether, ester, siloxane, acrylonitrile, vinylidene fluoride, hexafluoropropylene, acrylate, methacrylate, styrene, vinyl acetate, vinyl chloride, oxetane, and the like, and one type or two or more types of polymers may be used. The polymer structure is not particularly limited but is particularly preferably a polymer having an ether structure, such as polyethylene oxide.

In the lithium secondary battery of this embodiment, in the case of a liquid-type battery, an electrolyte solution is placed in a battery container; in the case of a gel-type battery, a precursor solution that contains a polymer dissolved in an electrolyte solution is placed in a battery container; and in the case of a solid-electrolyte battery, an uncrosslinked polymer in which an electrolyte salt is dissolved is placed in a battery container.

The lithium secondary battery according to this embodiment can be formed into a cylindrical shape, a coin shape, a prismatic shape, or any other shape. The basic configuration of the battery is the same regardless of the shape, and the design can be changed according to the purpose. For example, a cylindrical battery is obtained as follows. A negative electrode prepared by applying a negative electrode active material to a negative electrode current collector and a positive electrode prepared by applying a positive electrode active material to a positive electrode current collector are wound with a separator interposed therebetween, the resulting wound body is housed in a battery can, a non-aqueous electrolyte solution is injected into the battery can, insulating plates are placed on upper and lower portions, and the battery can is sealed in this state. In the case of an application to a coin-shaped lithium secondary battery, a stack including a disk-shaped negative electrode, a separator, a disk-shaped positive electrode, and a stainless steel plate is housed in a coin-shaped battery can, a non-aqueous electrolyte solution is injected into the battery can, and the battery can is sealed.

### EXAMPLES

The present invention will be described in more detail below by way of Examples. It should be noted that the present invention is not limited to these Examples.

### Raw Materials Used

### Polyisocyanate Compound (a)

Polyisocyanate compound (a1): Isophorone diisocyanate (molecular weight: 222.3, number of functional groups: 2)
Polyisocyanate compound (a2): Hydrogenated diphenylmethane diisocyanate (molecular weight: 262, number of functional groups: 2)

### Polyolefin (b1)

Polyolefin polyol (b1): Kraysol LBH-P2000 (polybutadiene polyol, manufactured by CRAY VALLEY) (molecular weight: 2,000, number of functional groups: 2)

### Polycarbonate (b2)

Polycarbonate polyol (b21): DURANOL PCDL T5652 (1,5-pentanediol and 1,6-hexanediol-based polycarbonate polyol, manufactured by Asahi Kasei Corporation) (molecular weight: 2,000, number of functional groups: 2)
Polycarbonate polyol (b22): ETERNACOLL UH-200 (1,6-hexanediol-based polycarbonate polyol, manufactured by UBE Corporation) (molecular weight: 2,000, number of functional groups: 2)

### Compound Having Hydrophilic Group and One or More Active Hydrogen Groups (c)

•Dimethylolpropionic acid (Bis-MPA) (molecular weight: 134.17, number of functional groups: 2)

### Chain Extender (d)

Amine extender (EDA): Ethylenediamine (molecular weight: 60.1, number of functional groups: 2)
Amine extender (DETA): Diethylenetriamine (molecular weight: 103.17, number of functional groups: 3)

### Neutralization Salt

Neutralization salt (TEA): Triethylamine
Neutralization salt (Li): Lithium hydroxide monohydrate (manufactured by NACALAI TESQUE, INC.)

### Production of Aqueous Polyurethane Resin Dispersion

### Example 1

In a four-necked flask equipped with a stirrer, a reflux condenser, a thermometer, and a nitrogen inlet tube, 66.1 parts by mass of polyolefin polyol (b1), 10.0 parts by mass of polycarbonate polyol (b21), 4.8 parts by mass of dimethylolpropionic acid (Bis-MPA), 18.4 parts by mass of polyisocyanate compound (a1), and 100 parts by mass of methyl ethyl ketone were placed. Subsequently, the resulting mixture was reacted at 75° C. for two hours to obtain a methyl ethyl ketone solution of a polyurethane prepolymer. This solution had a free isocyanate group content of 0.85% relative to nonvolatile matter.

Next, the solution was cooled to 45° C. and then neutralized by adding 1.5 parts by mass (a 10% aqueous solution) of lithium hydroxide monohydrate dissolved in water. Subsequently, emulsification reaction was conducted using a homogenizer while 186 parts by mass of water was gradually added to the solution. To the resulting emulsified dispersion, an aqueous solution in which 0.7 parts by mass of diethylenetriamine (DETA) was dissolved in 27.00 parts by mass of water was added, and the resulting mixture was then reacted for one hour. Subsequently, the methyl ethyl ketone serving as the reaction solvent was distilled under reduced pressure to obtain an aqueous polyurethane resin dispersion having a nonvolatile matter (solid) content of 35% by mass. Here, the crosslink density per molecular weight of 1,000 of a resin solid component contained in the aqueous polyurethane resin dispersion in Example 1 can be calculated as follows using the above-described mathematical expression of the crosslink density. 0.7 (parts: amount of DETA)/103.17 (molecular weight of DETA) /100 (parts: total amount) × 1000 ≈ 0.07

### Examples 2 to 6 and Comparative Examples 1 to 4

Aqueous polyurethane resin dispersions were synthesized by the same method as that described in Example 1 except that the composition was changed to the corresponding composition shown in Table 1.

### Evaluation Methods

A film used in the evaluations below was prepared using the above aqueous polyurethane resin dispersion under the following conditions.
Conditions for film preparation: 40° C. × 15 hours + 80° C. × 6 hours + 120° C. × 20 minutes
Dry film thickness = about 300 µm

An electrolyte solution used in the evaluations below was the following.
Electrolyte solution: Ethylene carbonate/Ethyl methyl carbonate = 1/1 (volume ratio) mixed solution

### Electrolyte Solution Resistance

About 0.2 g of the film prepared as described above was cut to prepare a specimen. The mass of the specimen before immersion was measured, and the specimen was then immersed in the electrolyte solution at 70° C. for three days. Subsequently, the temperature was returned to room temperature, and the electrolyte solution on the surface was then wiped off. Subsequently, the mass of the specimen after immersion was measured. A rate of increase in mass (%) was calculated on the basis of the following formula. A lower rate of increase in mass indicates better electrolyte solution resistance.

$$\begin{matrix}\text{Rate of increase in mass (\%) = (mass after immersion -} \\ \text{mass before immersion)/mass before immersion}\end{matrix}$$

### Ionic Conductivity

The film prepared as described above was cut into a circular shape with a diameter of 14 mm to prepare a specimen. The mass and the film thickness of the specimen were measured, and the specimen was then immersed in the electrolyte solution for 12 hours. Subsequently, the immersed specimen was attached to a measurement jig, a pressure was then applied, and the ionic conductivity was measured.

### Method for Preparing Battery Used for Experiments

### Preparation of Positive Electrode

In a planetary mixer, 100 parts by mass of LiNi_{⅓}Co_{⅓}Mn_{⅓}O₂ (NCM) serving as a positive electrode active material, 7.8 parts by mass of acetylene black (Li-400, manufactured by Denka Company Limited) serving as a conductive agent, 6 parts by mass of polyvinylidene fluoride serving as a binder, and 61.3 parts by mass of N-methyl-2-pyrrolidone serving as a dispersion medium were mixed together to prepare a positive electrode slurry having a solid content of 65% by mass. Pure water was used to adjust the solid content. The positive electrode slurry was applied to aluminum foil having a thickness of 15 µm with a coating machine, then dried at 130° C., and then roll-pressed to obtain a positive electrode with a positive electrode active material weight of 22 mg/cm².

### Preparation of Negative Electrode

Ninety-five parts of a mixture of SiO (average particle size: 4.5 µm, specific surface area: 5.5 m²/g) and graphite (average particle size: 18 µm, specific surface area: 3.2 m²/g) having a content ratio of 20:80 and serving a negative electrode active material, 2 parts of acetylene black (manufactured by Denka Company Limited) serving as a conductive agent, 0.8 parts of a carboxymethylcellulose salt (WS-C, manufactured by DKS Co., Ltd.) serving as a dispersant and a binder, and 0.2 parts (on a solid basis) of a fibrous nanocarbon dispersion (specific surface area: 400 to 500 m²/g, fiber diameter: 1 to 4 nm) and 2 parts (on a solid basis) of the prepared aqueous polyurethane resin dispersion serving as binders were mixed together, and the mixture was then stirred with a Homodisper to prepare a negative electrode slurry so as to have a solid content of 48% by mass. Pure water was used to adjust the solid content. The negative electrode slurry was applied to electrolytic copper foil having a thickness of 10 µm with a roll coater (Micro Coater, manufactured by Thank-Metal Co., Ltd.), then dried at 120° C., and then roll-pressed to obtain a negative electrode with a negative electrode active material weight of 7 mg/cm².

### Preparation of Lithium Secondary Battery

After the preparation of the positive electrode and the negative electrode, the positive electrode and the negative electrode were stacked on top of each other with a polyolefin-based separator interposed therebetween. A tab lead was ultrasonically welded on each of the positive electrode side and the negative electrode side to prepare a stack with tab leads. The stack with tab leads was placed in an aluminum laminate package, and the package was then sealed such that an opening for injecting an electrolyte solution was left to prepare a battery before electrolyte solution injection. The battery before electrolyte solution injection had a positive electrode area of 18 cm² and a negative electrode area of 19.8 cm². Subsequently, an electrolyte solution prepared by dissolving LiPF₆ (1.0 mol/L) in a mixed solvent of ethylene carbonate and diethyl carbonate with a volume ratio of 30:70 was injected from the opening, and the opening was then sealed to obtain a battery for evaluation.

### Electrode Binding Property Evaluation

### Binding Property Evaluation in Dry State

An electrode obtained above was bent by 180° such that the coated surface thereof was located outside, and then unbent. Subsequently, the degree of coming off of the active material on the coated surface was determined by visual observation. The electrode used was the negative electrode.

Evaluation criteria:
5 points: 0% or more and less than 25% came off
4 points: 25% or more and less than 50% came off
3 points: 50% or more and less than 75% came off
2 points: 75% or more and less than 100% came off
1 point: 100% came off

### Binding Property Evaluation in Wet State

The electrode obtained above was cut into a circular shape with a diameter of 12 mm to prepare a specimen. The specimen was placed in a 50 mL sample tube, and 5 mL of an electrolyte solution (ethylene carbonate/ethyl methyl carbonate = 1/1 (volume ratio) mixed solution) was then placed. Thus, the specimen was immersed for 24 hours.

Subsequently, the sample tube was placed in an ultrasonic cleaning device (38 kHz, SND Co., Ltd.) and subjected to ultrasonic cleaning treatment for 10 minutes. Subsequently, the degree of coming off of the active material on the coated surface of the electrode was determined by visual observation. The evaluation criteria were the same as those in the binding property evaluation in the dry state.

### 1 kHz ACR

As for 1 kHz alternating current resistance (ACR), after constant current-constant voltage (CCCV) charging was performed at a current value of 0.2C for 12 hours, the value of resistance at a frequency of 1 kHz was measured with an impedance analyzer (SP-150, manufactured by BioLogic).

### Discharge Retention Rate

The discharge retention rate was measured as follows. A cycle of constant-current (CC) charging at a current density corresponding to 0.5C to 4.2 V and subsequent CC discharging at a current density corresponding to 0.5C to 2.7 V was performed 300 times at 20° C. A value (%) determined by dividing a 1C discharge capacity after the 300 cycles by a 1C discharge capacity at the first cycle was determined as the discharge retention rate.

The experimental results are shown below.

TABLE 1

| | Example 1 | Example 2 | Example 3 | Example 4 | Example 5 | Example 6 | Comparative Example 1 | Comparative Example 2 | Comparative Example 3 | Comparative Example 4 |
|---|---|---|---|---|---|---|---|---|---|---|
| Polyisocyanate compound (a1) | 18.4 | 18.7 | 19.1 | 18.7 | | 18.7 | 18.4 | 19.1 | 18.7 | 25.8 |
| Polyisocyanate compound (a2) | | | | | 21.6 | | | | | |
| Polyolefin polyol (b1) | 66.1 | 37.7 | 5.0 | 37.7 | 36.1 | 37.7 | 76.1 | | 37.7 | 32.9 |
| Polycarbonate polyol (b21) | 10.0 | 38.1 | 70.4 | | 36.8 | 38.1 | | 75.4 | 38.1 | 33.3 |
| Polycarbonate polyol (b22) | | | | 38.1 | | | | | | |
| (b1)/{(b1) + (b2)} | 0.87 | 0.50 | 0.07 | 0.50 | 0.50 | 0.50 | 1.00 | 0.00 | 0.50 | 0.50 |
| (b2)/{(b1) + (b2)} | 0.13 | 0.50 | 0.93 | 0.50 | 0.50 | 0.50 | 0.00 | 1.00 | 0.50 | 0.50 |
| Bis-MPA (c) | 4.8 | 4.8 | 4.8 | 4.8 | 4.8 | 4.8 | 4.8 | 4.8 | 4.8 | 4.8 |
| Amine extender (EDA) (d) | | | | | | | | | 0.6 | |
| Amine extender (DETA) (d) | 0.7 | 0.7 | 0.7 | 0.7 | 0.7 | 0.7 | 0.7 | 0.7 | 0.1 | 3.2 |
| Neutralization salt (TEA) | | | | | | 3.6 | | | | |
| Neutralization salt (Li) | 1.5 | 1.5 | 1.5 | 1.5 | 1.5 | | 1.5 | 1.5 | 1.5 | 1.5 |
| Crosslink density [mol/kg] | 0.07 | 0.07 | 0.07 | 0.07 | 0.07 | 0.07 | 0.07 | 0.07 | 0.01 | 0.31 |
| Electrolyte solution resistance | 66 | 437 | 815 | 451 | 537 | 441 | 43 | 1054 | 521 | 287 |
| Ionic conductivity [mS/cm] | 1.2 | 1.7 | 2.1 | 1.6 | 1.8 | 1.6 | 0.8 | 2.3 | 1.6 | 1.4 |
| Binding property evaluation in dry state | 5 | 5 | 4 | 5 | 5 | 5 | 5 | 4 | 5 | 2 |
| Binding property evaluation in wet state | 5 | 5 | 4 | 5 | 5 | 5 | 5 | 1 | 3 | 4 |
| 1 kHz ACR | 191 | 183 | 176 | 186 | 189 | 184 | 212 | 178 | 189 | 186 |
| Discharge retention rate | 88 | 92 | 86 | 91 | 92 | 84 | 83 | 78 | 49 | 67 |

The comparison between Examples 1 to 6 and Comparative Examples 1 to 4 showed that the use of the polyurethane resin dispersions of this embodiment provided good ionic conductivity, binding properties, resistance, and discharge retention rate in a balanced manner.

### Impossible or Impractical Circumstances

Since the aqueous polyurethane resin dispersion of this embodiment has a complex structure, it is difficult to represent the structure by a general formula. Furthermore, unless the structure is defined, characteristics of the substance that are determined according to the structure cannot also be easily defined. Thus, it is impossible to define the aqueous polyurethane resin dispersion of this embodiment directly based on its structure or characteristics.

### Industrial Applicability

The aqueous polyurethane resin dispersion of this embodiment can be used as a binder for an electrode of a lithium secondary battery, and the electrode using the binder is used to produce various lithium secondary batteries. The lithium secondary batteries produced can be used for various mobile devices such as mobile phones, notebook personal computers, personal digital assistants (PDA), video cameras, and digital cameras and, furthermore, can be used as medium-sized and large-sized lithium secondary batteries installed in, for example, power-assisted bicycles and electric cars.

The present invention is not limited to the above-described embodiments and can be realized in various configurations without departing from the gist thereof. For example, the technical features in the embodiments and Examples corresponding to the technical features in each of the aspects described in the section of Summary of Invention can be replaced or combined as appropriate to solve part or the entirety of the above-described problems or to attain part or the entirety of the above-described advantageous effects. In addition, unless the technical features are described as being essential in the present description, the technical features can be omitted as appropriate.

1. An aqueous polyurethane resin dispersion for binders that are used in lithium secondary batteries,
the aqueous polyurethane resin dispersion comprising a polyurethane resin dispersed in water, the polyurethane resin being obtained by reacting a polyisocyanate compound (a), a compound (b) having two or more active hydrogen groups, a compound (c) having a hydrophilic group and one or more active hydrogen groups, and a chain extender (d),
wherein the compound (b) contains a polyolefin (b1) having two or more active hydrogen groups and a polycarbonate (b2) having two or more active hydrogen groups and having 6 or less consecutive carbon atoms, and
a crosslink density per molecular weight of 1,000 of a resin solid component contained in the aqueous polyurethane resin dispersion is 0.02 mol/kg or more and 0.28 mol/kg or less.

2. The aqueous polyurethane resin dispersion for binders according to claim 1,
wherein an amount of the polycarbonate (b2) is 5 parts by mass or more and 95 parts by mass or less relative to 100 parts by mass of a total blending amount of the polyolefin (b1) and the polycarbonate (b2).

3. The aqueous polyurethane resin dispersion for binders according to claim 1,
wherein an amount of the polycarbonate (b2) is 40 parts by mass or more and 80 parts by mass or less relative to 100 parts by mass of a total blending amount of the polyolefin (b1) and the polycarbonate (b2).

4. The aqueous polyurethane resin dispersion for binders according to claim 1,
wherein the polyisocyanate compound (a) includes at least one of an aromatic polyisocyanate and an alicyclic polyisocyanate.

5. The aqueous polyurethane resin dispersion for binders according to claim 1,
wherein the polyolefin (b1) includes a polyolefin containing two or more hydroxy groups.

6. The aqueous polyurethane resin dispersion for binders according to claim 1,
wherein the polycarbonate (b2) includes a polycarbonate containing two or more hydroxy groups.

7. The aqueous polyurethane resin dispersion for binders according to claim 1,
wherein the compound (c) includes a compound having an active hydrogen group and a carboxy group.

8. The aqueous polyurethane resin dispersion for binders according to claim 1,
wherein the chain extender (d) includes a triamine.

9. The aqueous polyurethane resin dispersion for binders according to claim 1,
wherein an amount of the chain extender (d) is 0.2 parts by mass or more and 1 part by mass or less relative to 100 parts by mass of a total blending amount of the polyisocyanate compound (a), the compound (b), the compound (c), and the chain extender (d).

10. A binder for electrodes, the binder comprising:
the aqueous polyurethane resin dispersion for binders according to claim 1.

11. A lithium secondary battery comprising:
an electrode using the binder for electrodes according to claim 10.

12. A lithium secondary battery comprising:
an electrode using the aqueous polyurethane resin dispersion for binders according to claim 1,
wherein an amount of the polycarbonate (b2) is 5 parts by mass or more and 95 parts by mass or less relative to 100 parts by mass of a total blending amount of the polyolefin (b1) and the polycarbonate (b2).

13. A lithium secondary battery comprising:
an electrode using the aqueous polyurethane resin dispersion for binders according to claim 1, wherein an amount of the polycarbonate (b2) is 40 parts by mass or more and 80 parts by mass or less relative to 100 parts by mass of a total blending amount of the polyolefin (b1) and the polycarbonate (b2).

14. A lithium secondary battery comprising:
an electrode using the aqueous polyurethane resin dispersion for binders according to claim 1, wherein the polyisocyanate compound (a) includes at least one of an aromatic polyisocyanate and an alicyclic polyisocyanate.

15. A lithium secondary battery comprising:
an electrode using the aqueous polyurethane resin dispersion for binders according to claim 1, wherein the polyolefin (b1) includes a polyolefin containing two or more hydroxy groups.

16. A lithium secondary battery comprising:
an electrode using the aqueous polyurethane resin dispersion for binders according to claim 1, wherein the polycarbonate (b2) includes a polycarbonate containing two or more hydroxy groups.

17. A lithium secondary battery comprising:
an electrode using the aqueous polyurethane resin dispersion for binders according to claim 1, wherein the compound (c) includes a compound having an active hydrogen group and a carboxy group.

18. A lithium secondary battery comprising:
an electrode using the aqueous polyurethane resin dispersion for binders according to claim 1, wherein the chain extender (d) includes a triamine.

19. A lithium secondary battery comprising:
an electrode using the aqueous polyurethane resin dispersion for binders according to claim 1, wherein an amount of the chain extender (d) is 0.2 parts by mass or more and 1 part by mass or less relative to 100 parts by mass of a total blending amount of the polyisocyanate compound (a), the compound (b), the compound (c), and the chain extender (d).
